(19) United States
(12) Patent Application Publication
(10) Pub. No.: US 2006/0275574 A1
(43) Pub. Date: Dec. 7, 2006

(54) Oriented fiber structural wood products and methods of manufacture

(76) Inventor: Eric Cable, British Columbia (CA)

Correspondence Address: ST. ONGE STEWARD JOHNSTON & REENS, LLC, 986 BEDFORD STREET, STAMFORD, CT, 06905-5619, US

(21) Appl. No.: 11/503,739

(22) Filed: Aug. 14, 2006

Related U.S. Application Data
(62) Division of application No. 10/895,458, filed on Oct. 20, 2004.
(60) Provisional application No. 60/512,779, filed on Oct. 21, 2003.
(60) Provisional application No. 60/512,779, filed on Oct. 21, 2003.

(51) Int. Cl. B32B 3/00

(52) U.S. Cl. 428/58

(57) ABSTRACT

The present invention relates generally to the field of engineered wood products. More particularly, the invention relates to glued, solid wood products and methods of manufacture wherein the orientation of wood fiber within the products is designed to be misaligned with adjacent wood fiber within the product to improve strength characteristics of the product.

### RELATED APPLICATIONS

This application is a divisional of U.S. patent application Ser. No. 10/895,458, filed on Oct. 20, 2004, currently pending, which application claims priority to U.S. provisional application 60/512,779 filed on Oct. 21, 2003 and 60/620,301 filed on Oct. 20, 2004 and is related to U.S. Pat. No. 6,779,576 (issued on Aug. 24, 2004 and its divisional application), and PCT/CA02/00981, all of which are incorporated herein by reference.

### FIELD OF THE INVENTION

The present invention relates generally to the field of engineered wood products. More particularly, the invention relates to glued, solid wood products and methods of manufacture wherein the orientation of wood fiber within the products is designed to be misaligned with adjacent wood fiber within the product to improve strength characteristics of the product.

### BACKGROUND OF THE INVENTION

The use of wood fiber to created engineered wood products is well known. A large variety of products are made by assembling different sized and shaped pieces or blocks of wood fiber into a large variety of different products such as finger-jointed boards, edge-glued panels as well as various forms of beams and fiber board.

More specifically, it is known that the scrap wood from various high-end lumber operations such as sawmill operations contain useful quantities of wood fiber which can be salvaged for lower-end lumber operations including the production of finger-jointed wood products.

In finger-jointing processes, usable solid wood fiber is cut from scrap material and through shaping, gluing and clamping the ends of the scrap material are assembled to create longer lengths of wood. The resulting longer boards that are built up from shorter lengths have advantages over equivalent lengths of solid, single piece lumber including 1) they will often be cheaper, 2) using certain glues, they will often have structural strengths equivalent to or greater than the strengths of an equivalent length of solid, single-piece lumber and, 3) longer, stable and straight boards of lumber can be created.

As disclosed in Applicant's U.S. Pat. No. 6,779,576 and co-pending applications, a wood gluing and clamping method and apparatus is described which provides a high clamping pressure across a deck of a growing slab or panel of glued lumber. The system and apparatus generally includes a deck, a braking system, a series of one-way clamps and a horizontal displacement system for forming a panel of edge-glued lumber or a beam of face-glued lumber having superior structural strengths. Wood products created in accordance with this methodology generally have wood fiber parallel to the length of boards that make up the panel.

While the above technology has been effective in creating very versatile and strong wood products, there continues to be a need for wood products with enhanced properties. In particular, there has been a need for products where the strength properties continue to be improved and the consistency of the structural properties of the product is also improved by controlling the wood fiber orientation within the products.

### SUMMARY OF THE INVENTION

In accordance with one embodiment of the invention, there is provided a wood product comprising at least two edge-glued or two face-glued laths wherein adjacent laths have a wood-fiber orientation misaligned with respect to an adjacent lath.

In further embodiments, individual laths are cut from a panel of edge-glued boards at an oblique angle and/or each edge-glued board includes a plurality of finger-jointed blocks. The oblique angle may between 0 and 90 degrees and more preferably between 30 and 60 degrees. In a preferred embodiment, the wood-fiber orientation is substantially perpendicular to the wood fiber orientation of an adjacent lath.

In another embodiment, the invention provides a wood product as above wherein a combination of at least two edge-glued and two face-glued laths are assembled to form a wood product having misaligned fiber in at least two planes.

In a still further embodiment, the invention provides a method for producing a wood product including the step of obliquely cutting a panel of edge-glued boards into laths and may further include the steps of assembling and gluing the laths into a laminated wood product wherein adjacent laths have a wood-fiber orientation misaligned with respect to an adjacent lath.

In yet another embodiment, the invention also provides a method for producing a wood product comprising the steps of:
a) edge-gluing wood boards together to form an edge-glued panel;
b) cutting the edge-glued panel at an oblique angle to form a plurality of laths;
c) re-orienting a first lath relative to a second lath such that the wood fiber orientation of the first lath relative to the second lath is misaligned; and,
d) face-gluing or edge-gluing the first and second lath together to form the wood product.

### BRIEF DESCRIPTION OF THE DRAWINGS

Embodiments of the present invention will now be described, by way of example only, with reference to the attached Figures, wherein:

FIGS. 1a, 1b, and 1c, are schematic diagrams showing the general method of assembly of engineered wood products in accordance with the invention;

FIG. 2 is a schematic diagram of the general method of assembly of a face glued wood product in accordance with the invention;

FIG. 3 is a schematic diagram of the general method of assembly of an edge-glued wood product in accordance with the invention; and,

FIG. 4 is a schematic end view of a product prepared in accordance with the invention.

### DETAILED DESCRIPTION OF EMBODIMENTS

The present invention provides a method and system for creating face-glued or edge-glued wood products from solid wood fiber. Products manufactured in accordance with the methodology described herein have unique strength characteristics that make the products particularly suitable for use in structural applications.

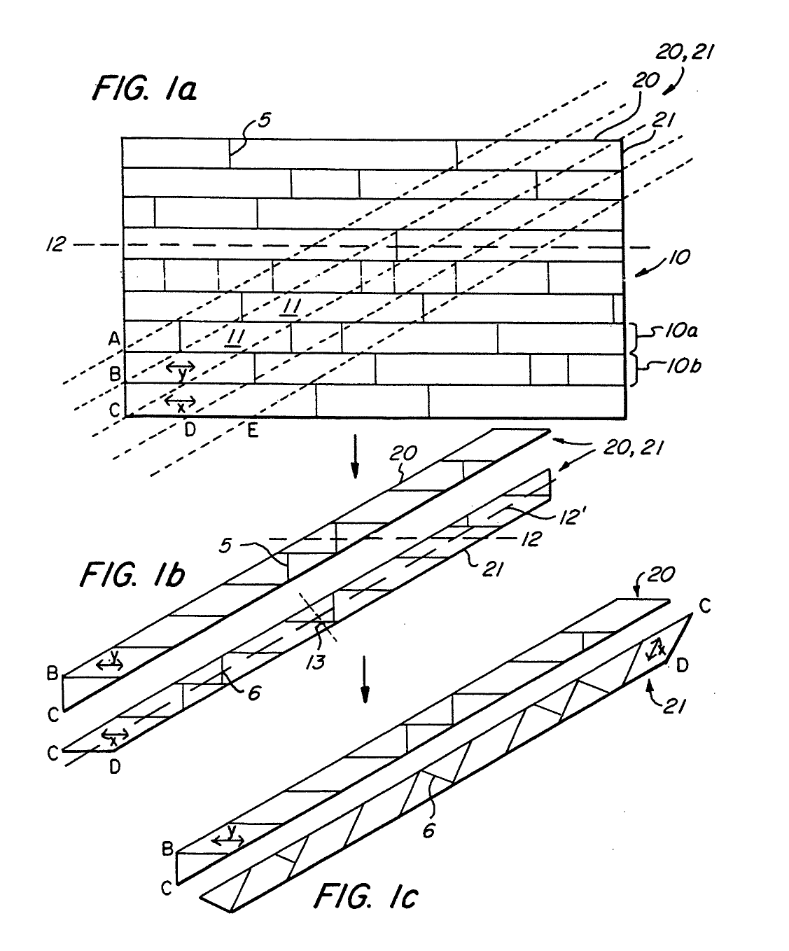

Generally, and with reference to FIG. 1a, a panel 10 of edge-glued boards 20 (which may be finger-jointed and assembled in accordance with Applicant's issued and co-pending patent applications) is cut obliquely along cut lines A through E to produce a number of laths of chosen widths (labeled as laths 20 and 21 in the following description). Within the context of this description, a lath is interpreted to mean the length of wood produced by cutting a panel at an oblique angle whereas a board is interpreted to mean the length of wood (with or without finger-jointing) that may be edge-glued to form a wood panel. In addition, within the context of this description, wood fiber is interpreted to mean wood fiber obtained from solid wood of dimensions and strengths enabling such solid wood to be machined into blocks of wood that can be finger-jointed and/or edge-glued together.

As shown, each board and lath may include a number of blocks 11 with finger-joints 5, 6 and will generally have a wood-fiber orientation parallel to that of the longitudinal axis 12 of the individual boards 10a, 10b or as shown by arrows X and Y on two adjacent boards. Subsequent to cutting, every second lath (21 in this example) is inverted relative to an adjacent lath 20 (as shown in FIG. 1c) such that the wood-fiber orientation is misaligned to the wood-fiber orientation of the adjacent lath. That is, as shown in FIG. 1b, fiber orientation lines X and Y are parallel whereas in FIG. 1c, after lath 21 has been inverted, fiber orientation lines X and Y are misaligned with respect to one another.

It is important to note that the resulting degree of misalignment after inversion or re-orientation is proportional to the oblique angle at which each lath 20, 21 is cut. Thus, if all cut lines are 45 degrees with respect to the longitudinal axes of laths 10a, 10b, after re-orientation of the laths (FIG. 1c), the wood-fiber orientation between adjacent laths will be perpendicular. Similarly, if the cut-angle is less than 45 degrees to the longitudinal axis of laths 10a, 10b the wood-fiber orientation between two adjacent laths will be two times the cut-angle if the cut-angle of two adjacent laths is constant.

In the case where the cut-angle of two laths is not the same, the degree of misalignment will be the sum of the two cut-angles. That is, laths may be paired with other laths that may have been cut at different angles so as to enable complete control of the relative orientation of wood-fibers within product.

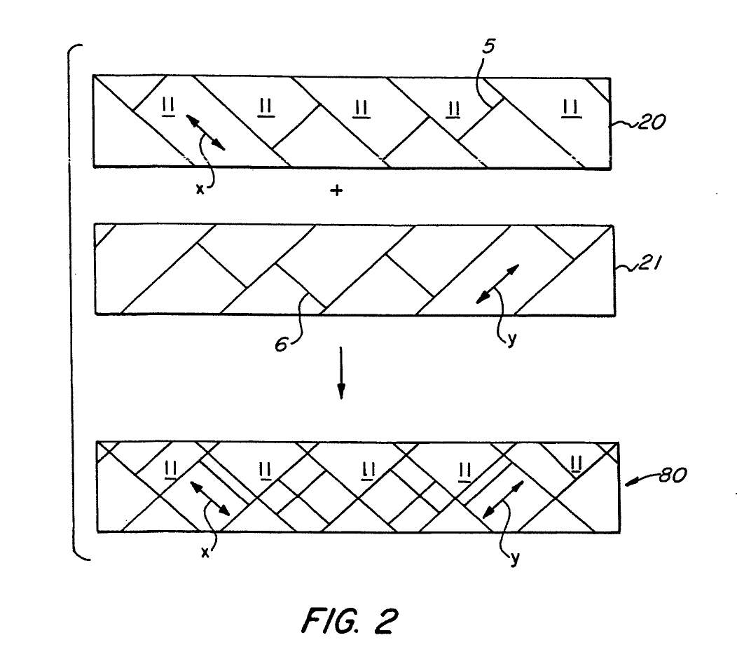

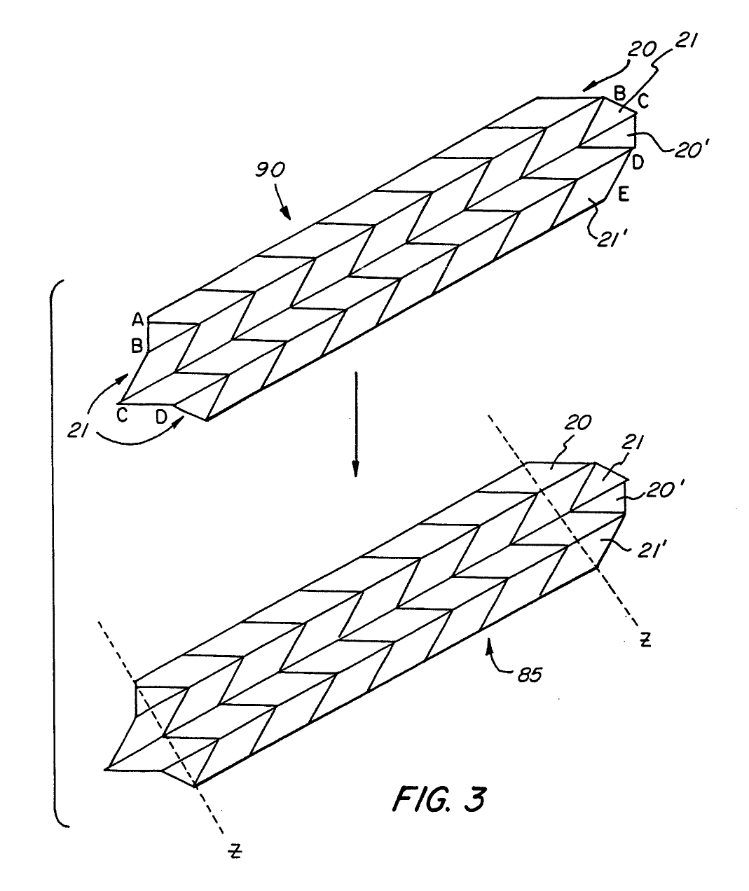

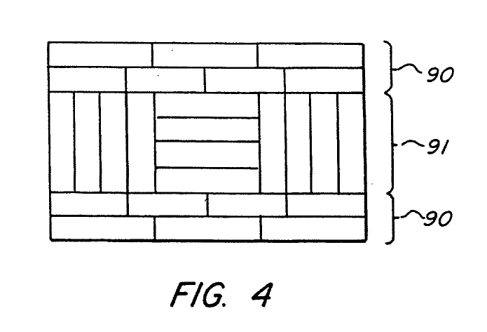

Re-oriented laths 20 and 21 may then be face-glued to produce a laminated wood product 80 as shown in FIG. 2 or a plurality of re-oriented laths may be edge-glued to produce a panel product 90 as shown in FIG. 3. Further still, as shown in FIG. 4, edge-glued laths 80 and face-glued laths 81 may be combined to produce products that are a combination of both edge-glued and face-glued products, thus creating products where fibers are misaligned in two planes.

Face-Glued Product

With reference to FIG. 2, two laths 20 (solid lines), 21 (dotted lines) are overlaid and glued together to form a face-glued product 80. As noted above, different products may be manufactured from more than two laths.

In the construction of multi-layered products, most products will be assembled such that each lath alternates between non-inverted laths 20 and inverted laths 21. Consequently, the orientation of the wood fibers within each lamina (assuming an approximate 45 degree oblique cut) will be approximately perpendicular to those of the next lamina, thereby creating a web effect of the wood fibers within the assembled product. It is this web effect that provides the unique strength characteristics of wood products manufactured by this methodology.

Edge-Glued Product

With reference to FIG. 3, four laths 20, 21, 20′ and 21′ are shown as being edge-glued together to form an edge-glued panel 90.

Following face-gluing and/or edge-gluing, the laminated product 80 or panel product 85 may be cut to desired lengths (shown by cut lines Z in FIG. 3), widths or processed, as may be desired.

Combined Face-Glued and Edge-Glued Product

As noted above, other products including combinations of face-glued and edge-glued products may be produced as may be desired where the fibers are misaligned in two planes. As shown in FIG. 4, combined face-glued and edge-glued products may be produced wherein different combinations of assembled face- and edge-glued laths may be glued together. In these products, it may be desired that particular combinations of fiber-alignments be created for a particular application. FIG. 4 is only representative of a possible design and it is understood that many combinations of lengths and widths of face-glued and edge-glued products may be produced in accordance with the methodology of the invention.

Assembly and Apparatus

A panel 10 of edge-glued boards can be created by known methods (including those by the Applicant as disclosed in Applicant's co-pending patent and applications), and may be composed of full length boards or finger-jointed blocks of wood. The panel 10 of edge-glued boards is oriented upon a deck proximal to a cutting apparatus. The panel 10 is then cut obliquely by a cutting apparatus, at an angle between 0 and 90 degrees with respect to the edge of the panel 10, thereby producing a plurality of laths 20, 21 of desired width and fiber-orientation. As noted, above, the cut-angle may be chosen based on the desired characteristics and relative orientation of fibers within the final products.

The laths are transported from the cutting apparatus, and half of the laths 20 are inverted by an inverting system. The inversion may be along the longitudinal axis 12′ of the lath or along the transverse axis 13 of the lath (end for end). Alternatively, all of the laths may be rotated about their longitudinal axis 12′ by 90 degrees, with half of the laths being rotated in the positive direction, and the other half in the negative direction to achieve the same result as above. The method and timing of lath inversion is not critical, so long as the end result is achieved of having adjacent edge or face-glued laths having substantially misaligned fiber orientations.

As noted above, the Applicant has previously described an edge-gluing and clamping apparatus and method capable of producing a continuously growing panel of edge-glued boards. It is intended that the method described herein may also be applied to the previously disclosed methods. This may be accomplished by including within the edge-gluing and clamping apparatus, a cutting system for obliquely cutting the continuously produced panel with the same orientation and angle (for example along cut line C in FIG. 1) into laths for use as described herein.

Due to the oblique cutting of the initial panel of edge-glued boards, there will occasionally be some smaller laths of insufficient length to create useful lumber. Such small laths may be finger-jointed to create longer boards, which may be used as described above in accordance with the invention.

Strength Characteristics of the Wood Products

Laminating the laths as described will produce products of increased strengths as compared to edge- or face-glued or combined edge- or face-glued products that do not have misaligned fiber. More particularly, when wood experiences stress above its modulus of rupture, the wood will tend to split along its natural grain as may be quantified by the modulus of rupture (MOR). Thus, by misaligning the wood fiber, there will be greater resistance to splitting along particular fiber weaknesses within the product as adjacent misaligned fiber will provide reciprocal reinforcement to prevent rupture. The resistance to splitting along a particular fiber direction also enhances the nail or spike holding abilities of the final products.

Similarly, the products will also have a more favorable modulus of elasticity (MOE) and coefficient of variation as a result of the randomization of weaker wood fiber within the final products that the methodology ensures. This randomization will minimize the degree of variation in the strengths of products produced by the process as, in instances where a weaker block of wood is incorporated into a product, the misalignment of fibers adjacent to the weakness will have a tendency to reinforce and otherwise minimize the potential weakness along a particular fiber direction.

In the particular instance of laths created from finger-jointed blocks of wood, reinforcement of finger-joints by the cross-orientation of fibers will be particularly beneficial as many finger-joints within a product will be reinforced along both their faces (by adjacent face-glued laths), and along their edges by adjacent boards.

The above-described embodiments of the present invention are intended to be examples only. Alterations, modifications and variations may be effected to the particular embodiments by those of skill in the art without departing from the scope of the invention, which is defined solely by the claims appended hereto.

1-8. (canceled)

9. A method for producing a wood product comprising the step of obliquely cutting a panel of edge-glued boards into laths.

10. The method as in claim 9 further comprising the steps of assembling and gluing the laths into a laminated wood product wherein adjacent laths have a wood-fiber orientation misaligned with respect to an adjacent lath.

11. A method for producing a wood product comprising the steps of:
a) edge-gluing wood boards together to form an edge-glued panel;
b) cutting the edge-glued panel at an oblique angle to form a plurality of laths;
c) re-orienting a first lath relative to a second lath such that the wood fiber orientation of the first lath relative to the second lath is misaligned; and,
d) face-gluing or edge-gluing the first and second lath together to form the wood product.

12. A method as in claim 11 wherein steps a) and b) are continuous.

13. A method as in claim 11 wherein step a) includes finger-jointing a plurality of wood blocks together to form each wood board.
